(19) United States
(12) Patent Application Publication
(10) Pub. No.: US 2005/0094317 A1
(43) Pub. Date: May 5, 2005

(54) Magnetoresistance effect element, magnetic head, head suspension assembly, magnetic reproducing apparatus, magnetoresistance effect element manufacturing method, and magnetoresistance effect element manufacturing apparatus

(75) Inventor: Tomomi Funayama, Hino-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/946,346

(22) Filed: Sep. 22, 2004

(30) Foreign Application Priority Data
Oct. 31, 2003 (JP) 2003-372451

(51) Int. Cl. G11B 5/127

(52) U.S. Cl. 360/313

(57) ABSTRACT

A CPP (Current Perpendicular-to-the-Plane) magnetoresistance effect element which causes sensing current to flow perpendicularly to the stacked faces of a plurality of conductive layers, the CPP magnetoresistance effect element comprises a composite layer in which a plurality of regions differing from one another are formed in a common layer in a mixed manner and which includes a current control region which is formed narrower than the stacked area of the composite layer and controls the flow rate of the sensing current, and an insulating material region which cuts off the flow of the sensing current.

### CROSS-REFERENCE TO RELATED APPLICATIONS

This application is based upon and claims the benefit of priority from prior Japanese Patent Application No. 2003-372451, filed Oct. 31, 2003, the entire contents of which are incorporated herein by reference.

### BACKGROUND OF THE INVENTION

1. Field of the Invention

This invention relates to a CPP (Current Perpendicular-to-the-Plane) magnetoresistance effect element which causes sensing current to flow perpendicularly to the direction in which a plurality of conductive layers are stacked, a CPP magnetoresistance effect element manufacturing method, a magnetic head having the magnetoresistance effect element, a head suspension assembly, a magnetic reproducing apparatus, and a magnetoresistance effect element manufacturing apparatus.

2. Description of the Related Art

In recent years, the size of magnetic recording apparatuses, including hard disk units, has been getting smaller rapidly and therefore the recording density has been getting higher remarkably. This trend is expected to get still stronger in the future. As the recording density has been getting higher, highly-sensitive sensors have been required. To meet the requirements, a Current Perpendicular-to-the-Plane giant magnetoresistance (CPP-GMR) element has been developed. In this type of element, unlike in an existing CIP (Current In Plane)-GMR element where sensing current flows in the film surface, sensing current flows in a direction perpendicular to the direction in which a plurality of dielectric films are stacked (e.g., refer to Jpn. Pat. Appln. KOKAI 10-55512 (reference 1) and U.S. Pat. No. 5,668,688 (reference 2)).

To improve the recording density, it is necessary to narrow the gaps and tracks. To makes the gaps narrower by applying a CPP-GMR element to a shield magnetic head, the current-carrying electrode and the magnetic shield have to be shared. Reference 1 and reference 2 have shown an example of using a magnetic shield to allow sensing current to flow. Use of such a magnetic head enables a recording signal to be reproduced, even if the recording bit size gets smaller. However, it is known that the lower resistance across the film thickness of the CPP-GMR element makes the absolute value of the variation of the resistance smaller and therefore makes it difficult to obtain a high output.

To overcome this problem, a CPP-GMR element which has both a suitable resistance value and a high resistance change rate has been contrived using a current confining effect (e.g., refer to Jpn. Pat. Appln. KOKAI 9-172212 (reference 3) and U.S. Pat. No. 6,560,077 (reference 4)). The current confining effect is the effect of causing current to flow, in a confined manner, through conductive parts distributed in a layer chiefly composed of insulating material, thereby increasing the resistance change rate. Hereinafter, the layer which produces the current confining effect is referred to as the current control layer.

In a magnetic head, it is important to cope with Barkhausen noise caused by the effects of magnetic domains. In the existing techniques, the noise is removed by externally applying a bias magnetic field. However, when the track width is made narrower to increase the recording density, the region sensitive to an external magnetic field (that is, a magnetic field produced by a recording medium) is influenced by the bias magnetic field, which leads to the disadvantage of lowering the reproduction sensitivity. Moreover, in the existing magnetoresistance effect element, its physical width is reflected directly in the track width. Mainly because of the limit of photolithographic technology, it is getting difficult to make a magnetoresistance effect element narrower. The reduction of the track width is approaching the limit.

As described above, there is a tradeoff between a narrower track width and a higher reproduction sensitivity. Coupled with the limit of photolithographic technology, it is getting harder to make the track width of a magnetic head narrower by the existing techniques.

### BRIEF SUMMARY OF THE INVENTION

According to an aspect of the present invention, there is provide a CPP (Current Perpendicular-to-the-Plane) magnetoresistance effect element which causes sensing current to flow perpendicularly to the stacked faces of a plurality of conductive layers, the CPP magnetoresistance effect element comprises a composite layer in which a plurality of regions differing from one another are formed in a common layer in a mixed manner and which includes a current control region which is formed narrower than the stacked area of the composite layer and controls the flow rate of the sensing current, and an insulating material region which cuts off the flow of the sensing current.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view schematically showing a first embodiment of a magnetoresistance effect element according to the present invention.

FIG. 2 is a sectional view conceptually showing the configuration of the main part of a magnetic head including the magnetoresistance effect element of FIG. 1.

FIG. 3 is a graph showing the result of measuring the effective track width of the magnetic head of FIG. 2.

FIG. 4 is a graph showing the result of measuring the reproduction output from a disk medium by use of the magnetic head of FIG. 2, while changing X.

FIG. 5 is a sectional view schematically showing a second embodiment of a magnetoresistance effect element according to the present invention.

FIG. 6 is a sectional view conceptually showing the configuration of the main part of a magnetic head including the magnetoresistance effect element of FIG. 5.

FIG. 7 is a graph showing the result of measuring the effective track width in the magnetic head of FIG. 6.

FIG. 8 is a graph showing the result of measuring the reproduction output from a disk medium by use of the magnetic head of FIG. 6, while changing X.

FIG. 9 is a sectional view to help explain a first step in the method of manufacturing the magnetoresistance effect element of FIG. 5.

FIG. 10 is a sectional view to help explain a second step in the method of manufacturing the magnetoresistance effect element of FIG. 5.

FIG. 11 is a sectional view to help explain a third step in the method of manufacturing the magnetoresistance effect element of FIG. 5.

FIG. 12 is a graph showing the result of examining the relationship between the ion beam irradiation time and the area resistance of the denatured region 6a in the step of FIG. 10.

FIG. 13 is a sectional view to help explain a fourth step in the method of manufacturing the magnetoresistance effect element of FIG. 5.

FIG. 14 is a sectional view to help explain a fifth step in the method of manufacturing the magnetoresistance effect element of FIG. 5.

FIG. 15 is a sectional view to help explain a first step in a method of manufacturing a magnetic head including the magnetoresistance effect element of FIG. 5.

FIG. 16 is a sectional view to help explain a second step in the method of manufacturing a magnetic head including the magnetoresistance effect element of FIG. 5.

FIG. 17 is a sectional view to help explain a third step in the method of manufacturing a magnetic head including the magnetoresistance effect element of FIG. 5.

FIG. 18 is a sectional view to help explain a fourth step in the method of manufacturing a magnetic head including the magnetoresistance effect element of FIG. 5.

FIG. 19 is a perspective view of a hard disk unit in which the magnetoresistance effect element according to the present invention can be installed.

FIG. 20 is an enlarged perspective view of the tip part extending from the actuator arm 155 of a magnetic head assembly 160 in the hard disk unit of FIG. 19, when looked at from the medium side.

### DETAILED DESCRIPTION OF THE INVENTION

### First Embodiment

FIG. 1 is a sectional view schematically showing a first embodiment of a magnetoresistance effect element according to the present invention. In FIG. 1, an air bearing surface (ABS) facing a disk medium (not shown) is shown. In FIG. 1, on a substrate (not shown), a seed layer 2, an antiferromagnetic layer 12, a pinning layer 3, an intermediate layer 6, a free layer 5, a composite layer 8, and a cap layer 10 are stacked one on top of another in that order. The seed layer 2 and cap layer 10 may be composed chiefly of a conductive film, such as Ta. The antiferromagnetic layer 12 may be composed chiefly of a metal magnetic material mainly made of PtMn. The pinning layer 3 may be composed chiefly of a stacked magnetic film, such as CoFe/Ru/CoFe. The intermediate layer 6 may be composed chiefly of a conductive film, such as Cu, Au, Ag, Pt, Pd, Ir, or Os. The free layer 5 may be composed chiefly of a metal magnetic material mainly made of CoFe/NiFe.

The composite layer 8 includes a current control region 8a and an insulating material region 8b which differ in conductivity. The current control region 8a is formed locally in a film chiefly composed of the insulating material region 8b. Preferably, the current control region 8a is formed in the central part of the insulating material region 8b. That is, the current control region 8a and insulating material region 8b are formed in a common composite layer 8 in a mixed manner. The current control region 8a is formed so as to have a smaller area than the stacked area of the composite layer 8. The current control region 8a, which is made mainly of, for example, aluminum oxide and Cu, limits the flow rate of sensing current, thereby producing a current confining effect. The insulating material region 8b cuts off the flow of sensing current so that the sensing current may flow into the current control region 8a.

The current control region 8a may be made mainly of an oxide, nitride, or oxynitride of at least one type of element selected from B, Si, Ge, Ta, W, Nb, Al, Mo, P, V, As, Sb, Zr, Ti, Zn, Pb, Th, Be, Cd, Sc, Y, Cr, Sn, Ga, In, Rh, Pd, Mg, Li, Ba, Ca, Sr, Mn, Fe, Co, Ni, Rb, and rare-earth metals. In addition, the current control region 8a is allowed to contain at least one type of metal selected from Cu, Au, Ag, Pt, Pd, Ir, and Os in the range of 1% or more to 50% or less.

The magnetoresistance effect element of FIG. 1, which is of the current perpendicular-to-the-plane (CPP) type, causes sensing current to pass perpendicularly to the stacked face of each layer. In addition, the element has a so-called spin valve structure where the resistance changes as a result of the direction of magnetization of the free layer 5 changing in response to an external magnetic field.

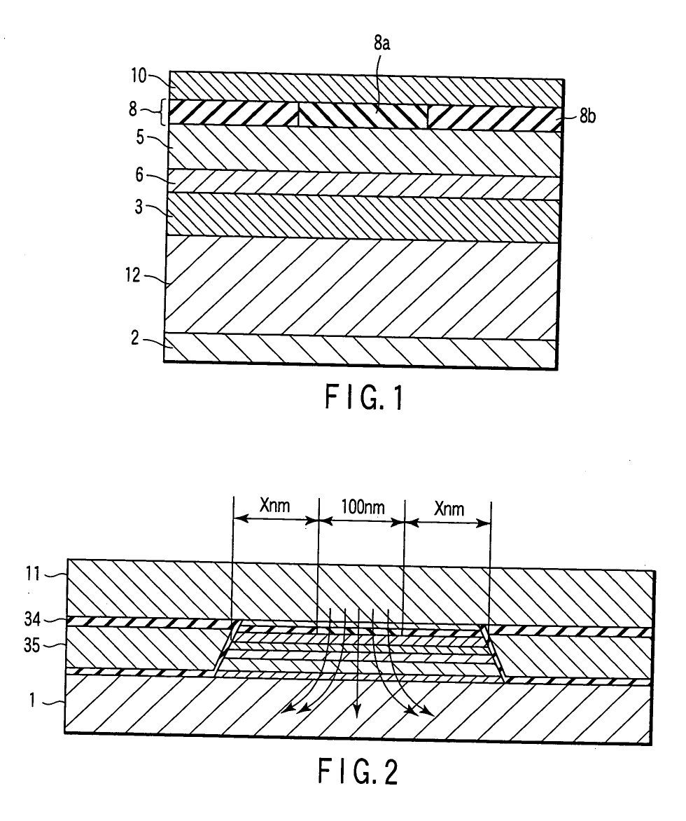

FIG. 2 is a sectional view conceptually showing the configuration of the main part of a magnetic head including the magnetoresistance effect element of FIG. 1. In FIG. 2, bias films 35 are formed on both sides of the magnetoresistance effect element so as to sandwich the magnetoresistance effect element between them. Above and below the resulting member, an upper lead 11 and a lower lead are formed respectively. That is, the upper lead 11 is stacked on the cap layer 10. The lower lead 1 is formed outside the seed layer 2.

The bias film 35, which is a ferromagnetic material film made of, for example, CoPt, applies a bias magnetic field to the free layer 5, thereby suppressing Barkhausen noise. The bias films 35 are insulated from the magnetoresistance effect element, the upper lead 11, and lower lead 1 by an insulating film 34 made of, for example aluminum oxide.

The upper lead 11 and lower lead 1, which are made mainly of, for example, NiFe, serve also as magnetic shields and electrodes for supplying sensing current.

In FIG. 2, sensing current flows convergently through the current control region 8a in the composite layer 8. That is, sensing current converges in the central part of the magnetoresistance effect element. This makes it possible to narrow effectively the width contributing to a change in the resistance value when the direction of magnetization of the free layer 5 changes in response to an external magnetic field.

In other words, it is possible to narrow the reproduce track width of the magnetic head effectively.

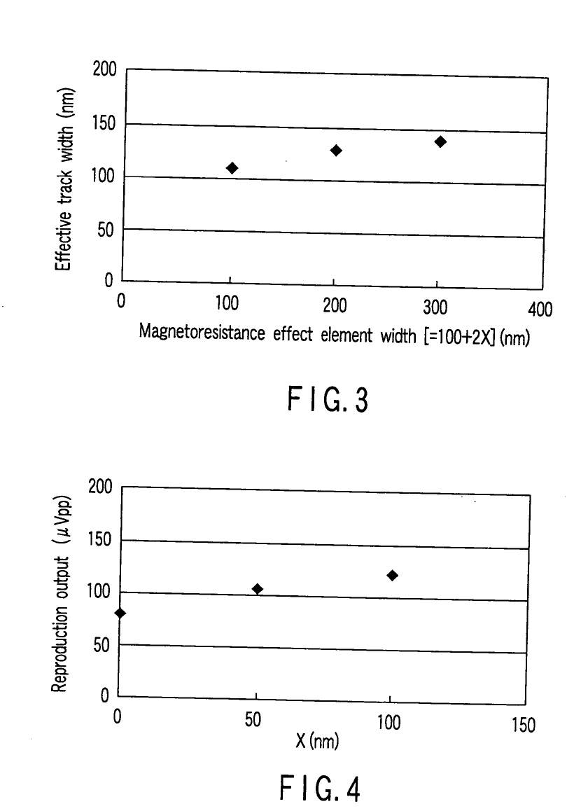

FIG. 3 is a graph showing the result of measuring the effective track width of the magnetic head of FIG. 2. On the abscissa axis, the width of the magnetoresistance effect element of FIG. 1 is plotted. Parameter X represents the width of the insulating material region 8b (shown in FIG. 2) on either side of the current control region 8a. If the width of the current control region 8a is 100 nanometers, the width of the magnetoresistance effect element is expressed as [100+2·X] (nanometers).

As shown in FIG. 3, even if the physical width of the magnetoresistance effect element changes from 100 to 200 and to 300 nanometers, the effective track width stays in the range from 100 to 150 nanometers. That is, an effective track width narrower than the width of the magnetoresistance effect element can be obtained. In addition, it is seen that, even if the width of the magnetoresistance effect element increases, the effective track width does not change much.

FIG. 4 is a graph showing the result of measuring the reproduction output from a disk medium by use of the magnetic head of FIG. 2, while changing X. In FIG. 4, a disk medium with Hc=4500 Oe and Mrt=0.3 memu/cm² was used and the reproduction output from an independent reproduced wave was measured with the amount of lift=5 nanometers. As shown in FIG. 4, the result has shown that the output increased as X became longer. The result is closely related not only to the increased output due to the current confining effect at the current conducting part (that is, the current control region 8a) but also to the decrease in the bias magnetic field applied to the current conducting part as a result of the increase in the distance between the current conducting part and the bias film 35 (that is, X gets larger).

As described above, in the first embodiment, the composite layer 8 where the current control region 8a is formed locally in the insulating material region 8b is provided in the CPP magnetoresistance effect element. This enables the current control region 8a to produce a current confining effect, thereby achieving a high reproduction output level. In addition, the distance between the bias films 35 can be kept as in the existing magnetoresistance effect element, which prevents the reproduction sensitivity from deteriorating. Furthermore, since the width of the current conducting part becomes narrower, an effectively narrower track width can be obtained and therefore the recording density can be improved.

### Second Embodiment

FIG. 5 is a sectional view schematically showing a second embodiment of a magnetoresistance effect element according to the present invention. In FIG. 5, the same parts as those in FIG. 1 are indicated by the same reference numerals. Only what is different from the latter will be explained.

In FIG. 5, the intermediate layer 6, which is formed between the pinning layer 3 and the free layer 5, includes the current control region 8a and the insulating material region 8b. That is, in the second embodiment, the current control region 8a and the insulating material region 8b are formed in the intermediate layer 6 of FIG. 1, thereby causing the intermediate layer 6 to also function as the composite layer 8.

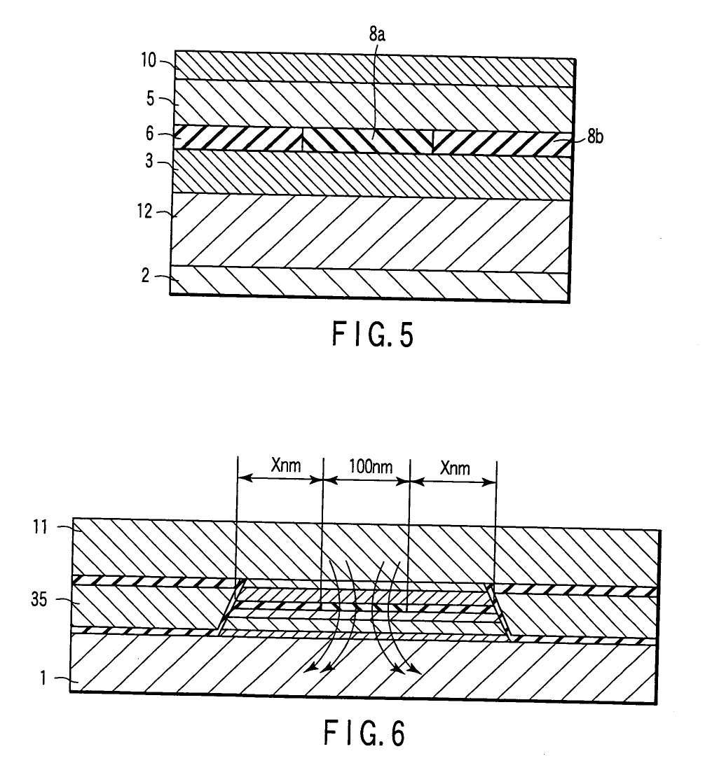

FIG. 6 is a sectional view conceptually showing the configuration of the main part of a magnetic head including the magnetoresistance effect element of FIG. 5. As in FIG. 2, in FIG. 6, bias films 35 are formed on both sides of the magnetoresistance effect element. Sensing current flows convergently in the central part of the magnetoresistance effect element.

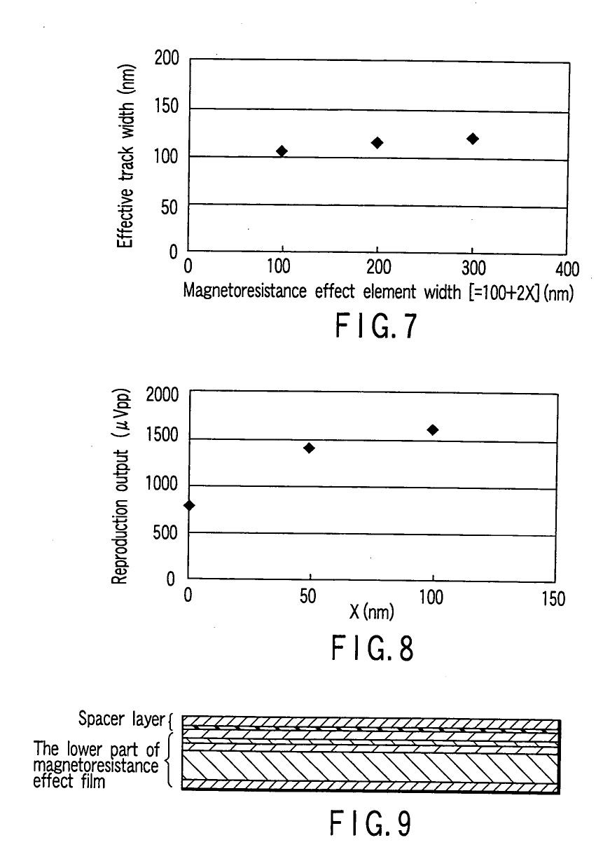

FIG. 7 is a graph showing the result of measuring the effective track width in the magnetic head of FIG. 6. The measuring conditions are the same as in FIG. 3. Comparison with FIG. 3 has shown that the effective track width shown in FIG. 7 is narrower than that of FIG. 3. That is, it is seen that the track width can be made narrower effectively.

FIG. 8 is a graph showing the result of measuring the reproduction output from a disk medium by use of the magnetic head of FIG. 6, while changing X. The measuring conditions are the same as those of FIG. 4. Comparison with FIG. 4 has shown that the level of the reproduction output is greater than that in FIG. 4. This is because the formation of the composite layer in the intermediate layer 6 of the spin valve stacked structure enhances the current confining effect in the current control region 8a. As described above, with the second embodiment, the resistance change rate obtained from the current confining effect can be increased further. Therefore, the second embodiment not only produces the effect of the first embodiment but also achieves a much higher reproduction output and improves the recording density by making the track width still narrower.

### Third Embodiment

Next, a method of manufacturing a magnetoresistance effect element according to a third embodiment of the present invention will be explained. A magnetoresistance effect element related to the present invention can be manufactured with an apparatus which is a combination of a vacuum vapor deposition unit for forming a metal film and an ion irradiation unit for irradiating an ion beam onto a metal film. The vapor vacuum deposition unit is provided with the function of processing a specimen in an atmosphere of oxygen. That is, a film forming unit, a unit having the function of oxidizing a specimen with a suitable oxygen partial pressure and a suitable exposure time under suitable temperature control, and a beam irradiation unit can be combined to realize a magnetoresistance effect element manufacturing apparatus of the invention.

FIG. 9 is a sectional view to help explain a first step in the method of manufacturing the magnetoresistance effect element of FIG. 5. In FIG. 9, a film of NiFe is formed on an Al—Ti—C substrate (not shown) serving as a lower lead/lower shield 1 (FIG. 6). Then, after the lower lead/lower shield 1 is patterned by photolithography and dry etching, a seed layer 2 made of Ta, an antiferromagnetic layer 12 made of PtMn, and a pinning layer 3 made of CoFe/Ru/CoFe are formed in that order. In the steps up to this point, the lower part of the magnetoresistance effect film is completed. Next, a film of Cu and a film of Al are formed on the lower part in that order, thereby producing an intermediate layer 6.

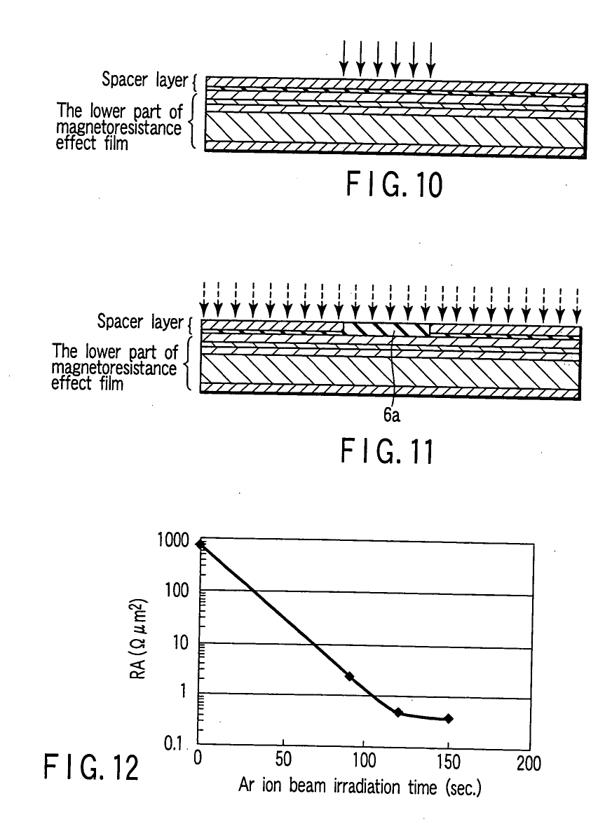

FIG. 10 is a sectional view to help explain a second step in the method of manufacturing the magnetoresistance effect element of FIG. 5. Following the state of FIG. 9, in the step of FIG. 10, an ion beam whose width corresponds to the track width is irradiated in and around the central part of the intermediate layer 6. For example, an Ar ion beam may be used as the ion beam. As a result of the ion beam irradiation, energy is injected from the beam into the irradiated region, thereby forming a denatured region 6a as shown in FIG. 11.

FIG. 11 is a sectional view to help explain a third step in the method of manufacturing the magnetoresistance effect element of FIG. 5. In this step, the multilayer film in the state of FIG. 10 is subjected to an oxidizing process by, for example, the IAO (Ion Assisted oxidation) method, thereby oxidizing the intermediate layer 6. As a result, the electric resistance characteristic of the denatured region 6a can be made different from that of the remaining region. That is, the irradiation time of the ion beam, the oxidizing process time, and the like are controlled suitably, which makes it possible to use only the denatured region 6a as the current control region and the remaining region as the insulating material region.

FIG. 12 is a graph showing the result of examining the relationship between the ion beam irradiation time and the area resistance of the denatured region 6a in the step of FIG. 10. The ordinate axis represents the area resistance.

As shown in FIG. 12, it is seen that the area resistance decreases rapidly according to the ion beam irradiation time. For example, when the irradiation time is, for example, 100 seconds or longer, the area resistance is 1 Ωμm² or less and therefore the denatured region 6a becomes almost a conductor. Conversely, when the ion beam irradiation time is 0, that is, when only the oxidizing process is carried out without ion beam irradiation, an area resistance of about 1 kΩμm² is obtained, with the result that the denatured region 6a becomes an insulating material. When the oxidizing process is not carried out, that is, when the intermediate layer 6 is made of metal, it has an area resistance of about 0.05 to 0.1 Ωμm². If the irradiation time is set to about 120 to 150 seconds, then an area resistance of 0.5 Ωμm² will be obtained.

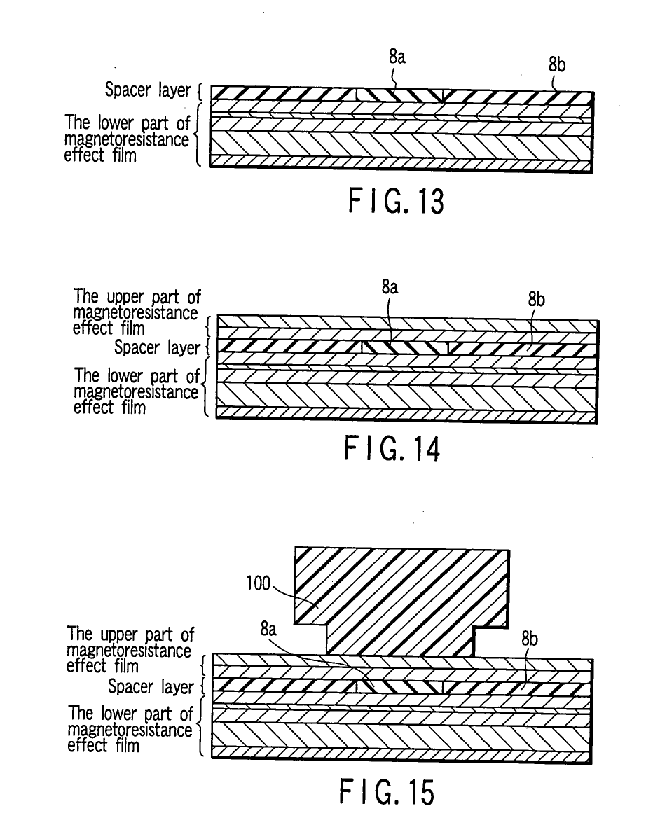

FIG. 13 is a sectional view to help explain a fourth step in the method of manufacturing the magnetoresistance effect element of FIG. 5. From the graph of FIG. 12, it is seen that an intermediate area resistance is obtained by irradiating an Ar ion beam for about 120 to 150 seconds and then carrying out an oxidizing process. Therefore, by this process, it is possible to use the denatured region 6a as the current control region 8a and the remaining region as the insulating material region 8b.

FIG. 14 is a sectional view to help explain a fifth step in the method of manufacturing the magnetoresistance effect element of FIG. 5. After a film of Cu is formed in the state of FIG. 13, a film of CoFe/NiFe, which will make a free layer 5, is formed. Then, a film of Ta is formed as a cap layer 10, which completes the upper part of the magnetoresistance effect element.

FIG. 15 is a sectional view to help explain a first step in a method of manufacturing a magnetic head including the magnetoresistance effect element of FIG. 5. A resist 100 whose width is greater than the width of the current control region 8a is formed on the stacked film of the cap layer 10 in the state of FIG. 14 in such a manner that the current control region 8a of the intermediate layer 6 is located almost in the central part of the width of the resist 100.

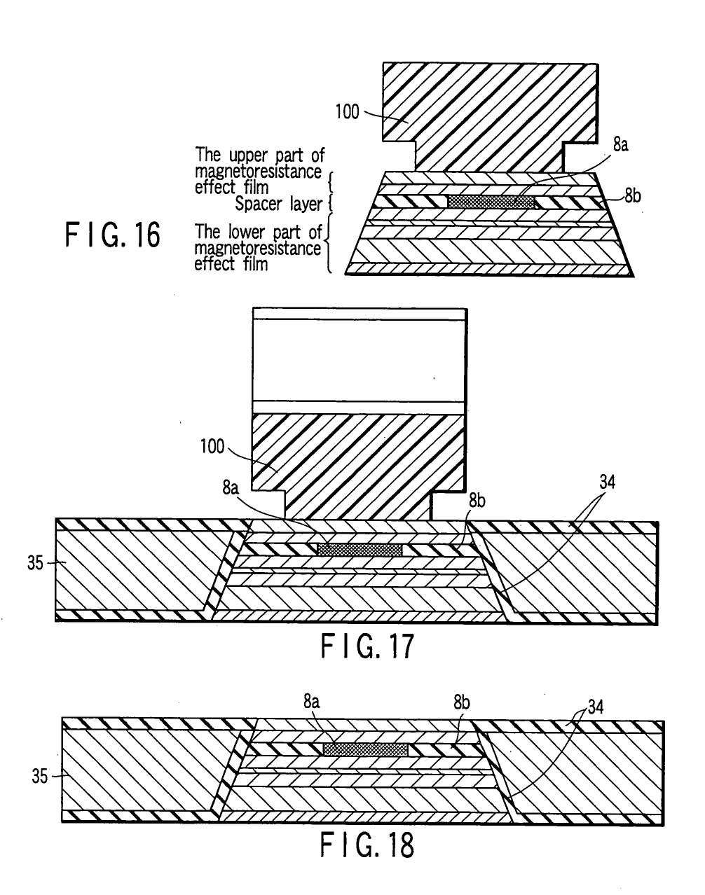

FIG. 16 is a sectional view to help explain a second step in the method of manufacturing a magnetic head including the magnetoresistance effect element of FIG. 5. In the state of FIG. 15, with the resist 100 as a mask, the magnetoresistance effect film is etched by ion milling. As a result, the magnetoresistance effect element is shaped as shown in FIG. 16, which achieves the necessary minimum size for a magnetic head.

FIG. 17 is a sectional view to help explain a third step in the method of manufacturing a magnetic head including the magnetoresistance effect element of FIG. 5. FIG. 18 is a sectional view to help explain a fourth step in the method of manufacturing a magnetic head including the magnetoresistance effect element of FIG. 5.

In the state of FIG. 16, with the resist 100 remaining as it is, a film of aluminum oxide is formed, thereby producing an insulating film 34. On the insulating film 34, a film of Cr is formed to provide a foundation for a bias film 35. On the Cr film, a film of CoPt is formed to make the bias film 35. Finally, a film of aluminum oxide is formed to make an insulating film 34 and then is lifted off. By these steps, the magnetic head of the invention is formed.

As described above, in the third embodiment, it is possible to obtain a magnetic head with a narrower track width capable of producing a high reproduction output as in the second embodiment. That is, it is possible to provide not only a reproduce head with an effective track width narrower than the physical width of the magnetoresistance effect element but also a magnetoresistance effect head capable of suppressing a drop in the output even if reducing the track width.

In addition, with the third embodiment, the denatured region 6a is formed by irradiating an ion beam onto the intermediate layer 8 of the spin valve film. The denatured region 6a is then subjected to an oxidizing process, thereby forming the composite layer 8. With a recent beam irradiation unit, a spot diameter ranging from 5 to 10 nanometers has been achieved. In the third embodiment, the width of the current control region 8a can be reduced to about 5 to 10 nanometers. That is, the track width can be decreased to the order of the diameter of an ion beam, which enables the recording density to be made higher remarkably.

In recent photolithographic technology, it is known that a track width of about 80 to 90 nanometers is the limit. In contrast, according to the third embodiment, it is possible to obtain an effective track width much narrower than the physical width of a magnetoresistance effect element determined by the limits of photolithographic techniques. That is, since a track width as narrow as about one half to one nineteenth the existing track width can be achieved, the contribution of the third embodiment to a higher recording density in disk mediums is great.

### Fourth Embodiment

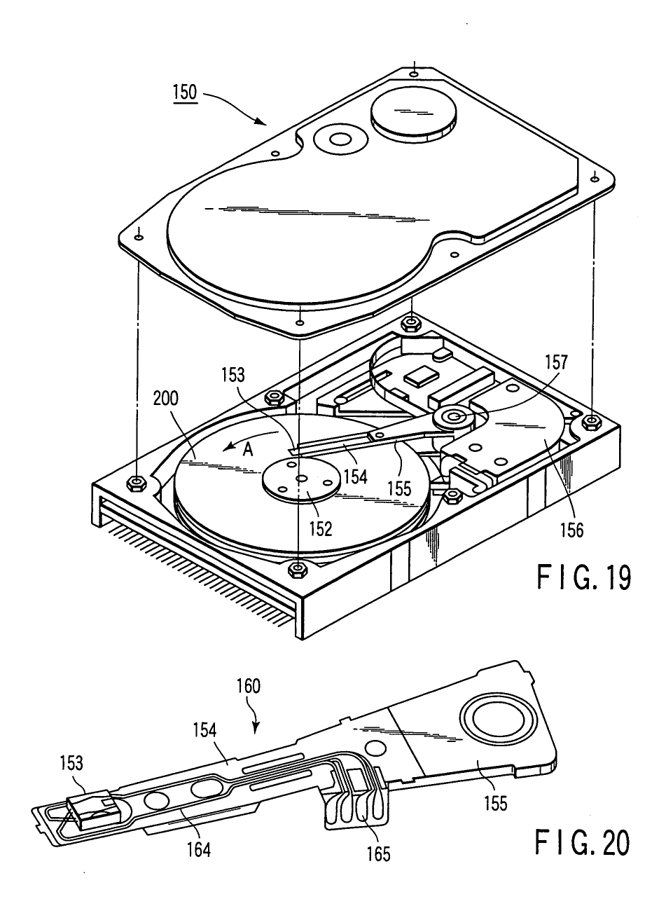

FIG. 19 is a perspective view of a hard disk unit in which the magnetoresistance effect element according to the present invention can be installed. A magnetoresistance effect element related to the present invention can be installed in a magnetic reproducing apparatus which reads digital data magnetically recorded on a magnetic recording medium. A typical magnetic recording medium is a platter built in a hard disk drive. In addition, a magnetoresistance effect element related to the present invention can be installed in a magnetic recording and reproducing apparatus which also has the function of writing digital data onto a magnetic recording medium.

In a hard disk unit 150 of FIG. 19, a rotary actuator is used to move a magnetic head. In FIG. 19, a recording disk medium 200 is installed on a spindle 152. The disk medium 200 is rotated in the direction shown by arrow A by a motor (not shown) which responds to a control signal from a driving unit control section (not shown). More than one disk medium 200 may be provided. This type of apparatus is known as the multi-platter type.

A head slider 153, which is provided at the tip of a thin-film suspension 154, stores information onto the disk medium 200 or reproduces the information recorded on the disk medium 200. The head slider 153 has the magnetic head of FIG. 2 or 6 provided near its tip.

The rotation of the disk medium 200 causes the air bearing surface (ABS) of the head slider 153 to float a specific distance above the surface of the disk medium 200. The present invention is applicable to a so-called contact running unit in which the slider is in contact with the disk medium 200.

The suspension 154 is connected to one end of an actuator arm 155 which includes a bobbin section (not shown) that holds a driving coil (not shown). A voice coil motor 156, a type of linear motor, is provided to the other end of the actuator arm 155. The voice coil motor 156 is composed of a driving coil (not shown) wound around the bobbin section of the actuator arm 155 and a magnetic circuit including a permanent magnet and a facing yoke which are provided in such a manner that the magnet and yoke face each other with the coil sandwiched between them.

The actuator arm 155 is held by ball bearings (not shown) provided in the upper and lower parts of the spindle 157 in such a manner that the arm 155 can be rotated freely by the voice coil motor 156.

### Fifth Embodiment

FIG. 20 is an enlarged perspective view of the tip part extending from the actuator arm 155 of a magnetic head assembly 160 in the hard disk unit of FIG. 19, when looked at from the medium side. In FIG. 20, the magnetic head assembly 160 has the actuator arm 155. A suspension 154 is connected to one end of the actuator arm 155. At the tip of the suspension 154, there is provided a head slider 153 including the magnetic head of FIG. 5 or 6. The suspension 154 has leads 164 for writing and reading a signal. The leads 164 are connected electrically to the individual electrodes of the magnetic head built in the head slider 153. The leads 164 are also connected to electrode pads 165.

As shown in FIGS. 19 and 20, a magnetic recording and reproducing apparatus which has a narrower track width than that of an existing hard disk unit and produces a higher reproduction output than that of the latter can be realized by implementing a hard disk unit using the magnetoresistance effect element of FIG. 1 or 5 and the magnetic head of FIG. 2 or 6. This configuration contributes to a much higher recording density.

This invention is not limited to the above embodiments.

For example, this invention may be applied to a so-called dual spin valve magnetoresistance effect element which includes two units each composed of a free layer, an intermediate layer, and a pinning layer, with the free layer shared by the two units. In this case, one of the two intermediate layers may be formed as a composite layer 8. Of course, both of the intermediate layers may be formed as composite layers 8.

While in the third embodiment, an Ar ion beam has been irradiated to form the current control region 8a, an electron beam may be irradiated to form the current control region 8a. In addition, a method of irradiating radiant rays can be considered.

1. A CPP (Current Perpendicular-to-the-Plane) magnetoresistance effect element which causes sensing current to flow perpendicularly to the stacked faces of a plurality of conductive layers, the CPP magnetoresistance effect element comprising:
a composite layer in which a plurality of regions differing from one another are formed in a common layer in a mixed manner and which includes
a current control region which is formed narrower than the stacked area of the composite layer and controls the flow rate of the sensing current, and
an insulating material region which cuts off the flow of the sensing current.

2. The CPP magnetoresistance effect element according to claim 1, wherein the magnetoresistance effect element is used in such a manner that it is positioned so as to face the recording side of a magnetic recording medium and in that the current control region is formed so as to have a width corresponding to the track width of the magnetic recording medium at the side facing the magnetic recording medium.

3. The CPP magnetoresistance effect element according to claim 1, wherein the current control region includes an insulating material which electrically insulates layers adjoining the composite layer from each other, and conductive materials which are formed in the insulating material in a distributed manner and electrically connect the adjoining layers to each other to cause the sensing current to flow in a confined manner.

4. The CPP magnetoresistance effect element according to claim 1, wherein the magnetoresistance effect element is a spin valve magnetoresistance effect element including a magnetization free layer and a magnetization fixing layer and in that the composite layer is formed as an intermediate layer between the magnetization free layer and the magnetization fixing layer.

5. The CPP magnetoresistance effect element according to claim 4, further comprising an antiferromagnetic layer which fixes the direction of magnetization of the magnetization fixing layer.

6. A magnetic head comprising:
a magnetoresistance effect element according to claim 1;
an electrode section which supplies the sensing current to the magnetoresistance effect element; and
a bias magnetic field applying section which applies a bias magnetic field to the magnetoresistance effect element.

7. A magnetic head comprising:
a magnetoresistance effect element according to claim 2;
an electrode section which supplies the sensing current to the magnetoresistance effect element; and
a bias magnetic field applying section which applies a bias magnetic field to the magnetoresistance effect element.

8. A magnetic head comprising:
a magnetoresistance effect element according to claim 3;
an electrode section which supplies the sensing current to the magnetoresistance effect element; and
a bias magnetic field applying section which applies a bias magnetic field to the magnetoresistance effect element.

9. A magnetic head comprising:
a magnetoresistance effect element according to claim 4;
an electrode section which supplies the sensing current to the magnetoresistance effect element; and
a bias magnetic field applying section which applies a bias magnetic field to the magnetoresistance effect element.

10. A magnetic head comprising:
a magnetoresistance effect element according to claim 5;
an electrode section which supplies the sensing current to the magnetoresistance effect element; and
a bias magnetic field applying section which applies a bias magnetic field to the magnetoresistance effect element.

11. A head suspension assembly comprising:
a magnetic head according to claim 6 and a support mechanism which supports the magnetic head in such a manner that the magnetic head faces the recording side of a magnetic recording medium.

12. A magnetic reproducing apparatus comprising a magnetic head according to claim 6 and reading magnetic information recorded on a magnetic recording medium by use of the magnetic head.

13. A magnetic reproducing apparatus comprising a head suspension assembly according to claim 11 and reading magnetic information recorded on a magnetic recording medium by use of the magnetic head.

14. A method of manufacturing a CPP (Current Perpendicular-to-the-Plane) magnetoresistance effect element which causes sensing current to flow perpendicularly to the stacked faces of a plurality of conductive layers, the method comprising:
a film forming step of forming a metal film; and
a denaturing step of denaturing the meal layer into a composite layer where an insulating material region which cuts off the flow of the sensing current and a current control region which limits the flow rate of the sensing current are mixed in a common layer, of supplying energy locally to the metal film, and of oxidizing the metal film after the energy supplying step is completed.

15. The method of manufacturing a CPP magnetoresistance effect element according to claim 14, wherein the energy supplying step is a step of irradiating a charged particle beam locally to the metal film, thereby supplying energy to the metal film.

16. The method of manufacturing a CPP magnetoresistance effect element according to claim 14, wherein the charged particle beam is an ion beam.

17. The method of manufacturing a CPP magnetoresistance effect element according to claim 15, wherein the charged particle beam is an electron beam.

18. A apparatus for manufacturing a CPP (Current Perpendicular-to-the-Plane) magnetoresistance effect element which causes sensing current to flow perpendicularly to the stacked faces of a plurality of conductive layers, the apparatus comprising:
a film forming section which forms a metal film; and
a denaturing section which denatures the meal layer into a composite layer where an insulating material region which cuts off the flow of the sensing current and a current control region which limits the flow rate of the sensing current are mixed in a common layer and which includes an irradiating section which irradiates a charged particle beam locally to the metal film and an oxidizing section which oxidizes the metal film to which the charged particle beam has been irradiated.
